(19) United States
(12) Patent Application Publication
(10) Pub. No.: US 2024/0248948 A1
(43) Pub. Date: Jul. 25, 2024

(54) APPARATUS TO EVALUATE TIME-SERIES DATA, PROGRAM TO EVALUATE TIME-SERIES DATA, AND METHOD TO EVALUATE TIME-SERIES DATA

(71) Applicants: TOSHIBA INFORMATION SYSTEMS (JAPAN) CORPORATION, Kawasaki-shi Kanagawa (JP); KYOTO UNIVERSITY, Kyoto-shi Kyoto (JP)

(72) Inventors: Hidetoshi OKUTOMI, Kawasaki Kanagawa (JP); Tomoyuki MAO, Kawasaki Kanagawa (JP); Ken UMENO, Kyoto-shi Kyoto (JP)

(73) Assignees: TOSHIBA INFORMATION SYSTEMS (JAPAN) CORPORATION, Kawasaki-shi Kanagawa (JP); KYOTO UNIVERSITY, Kyoto-shi Kyoto (JP)

(21) Appl. No.: 18/475,914

(22) Filed: Sep. 27, 2023

(30) Foreign Application Priority Data
Sep. 28, 2022 (JP) 2022-155450

(51) Int. Cl. G06F 17/11

(52) U.S. Cl. CPC G06F 17/11

(57) ABSTRACT

To achieve high accuracy and high processing speed, a time series data evaluation device is equipped with a probability calculation unit 201 that calculates the probability p(i) that ξt∈Ai; a division entropy calculation unit 202 that calculates division entropy using the measure in the subdivision interval by setting a subdivision section Bi (i=1, 2, . . . , M×Q) by further dividing the divided section Ai (i=1, 2, . . . , M) into Q equal parts; and a summation calculation unit 203 that performs a summation calculation of the divided interval range regarding the multiplication of the probability p(i) and the division entropy.

### TECHNICAL FIELD

This invention is with regards to a time series data evaluation device, a program for time series data evaluation as well as a time series data evaluation method

### PRIOR ART

Conventionally, when quantifying the degree of chaos in time-series data, competition has focused on how closely a curve can be created that approximates the Lyapunov exponent. Therefore, an exponent called the Lyapunov exponent has long been used as a means of measuring/quantifying chaos. The Lyapunov exponent is calculated based on the characteristics of the equation of the data generation source, so if the data generation source (the equation that generates the data, etc.) is unknown, it must be estimated using a large amount of data and complicated procedures. It is especially difficult and practically impossible to employ the Lyapunov exponent when performing real-time processing.

The following method called chaos scale is known for the above Lyapunov exponent. In the chaos scale, a mapping where T is defined on a straight line, is set to

$$\begin{matrix}[ \# 1 ] & \\ τ : I \to I ⊂ {ℝ}^{1} & \end{matrix}$$

And for the initial value of ξ₀∈I

$${ξ}_{t} = τ ( {ξ}_{t - 1} ) = {τ}^{t} ( {ξ}_{0} ) ,$$

$$t = 1 , 2 , … , n$$

A total of n+1 time series data obtained by n iterations of is defined as

$$\{ {ξ}_{0} , {ξ}_{1} , {ξ}_{2} , … , {ξ}_{n} \}$$

And when the divided interval obtained by dividing the interval I including ξₜ into M equal parts is represented by Aᵢ (i=1, 2, . . . , M), and when the divided interval satisfies the following formula (1),

$$\begin{matrix}[ \# 2 ] & \\ I = {U}_{i = 1}^{M} {A}_{i} , & ( 1 )\end{matrix}$$

$${A}_{i} ⋂ {A}_{j} = ∅ ( i \neq j )$$

Calculate p(i), p(i, j), p(j|i) from c₁(i), c₂(i, j).

$${c}_{1} ( i ) = \# \{ {ξ}_{t} ∈ {A}_{i} \vert t = 0 , 1 , 2 , … , n - 1 \} \qquad ( 2 )$$

$${c}_{2} ( i , j ) = \# \{ {ξ}_{t} ∈ {A}_{i} , {ξ}_{t + 1} ∈ {A}_{j} \vert t = 0 , 1 , 2 , … , n - 1 \} \qquad ( 3 )$$

Regarding the above equation (2), FIG. 1(a) shows the mapping area and interval number of the counter c₁(i), and regarding the above equation (3), FIG. 1(b) shows the counter c₂(i, j). shows the mapping area and interval number.

$$\begin{matrix}[ \# 3 ] & \\ p ( i ) = \frac{{c}_{1}^{( i )}}{n} & ( 4 )\end{matrix}$$

$$p ( i , j ) = \frac{{c}_{2}^{( i , j )}}{n} \qquad ( 5 )$$

$$p ( j \vert i ) = \frac{p ( i , j )}{p ( i )} = \frac{{c}_{2}^{( i , j )}}{{c}_{1}^{( i )}} \qquad ( 6 )$$

In the above, p(i) is the probability where ξₜ∈Aᵢ, p(i, j) is the probability where ξₜ∈Aᵢ, ξₜ+1∈Aⱼ, and p(j|i) is the conditional probability where ξₜ∈Aᵢ, ξₜ+1 εAⱼ.

Based on the above premise, the chaos measure H is calculated using formula (8) for the following definition formula (7).

$$\begin{matrix}[ \# 4 ] & \\ & \\\end{matrix}$$

$$\begin{matrix}H & = & {\sum }_{i = 1}^{M} p ( i ) {\sum }_{j = 1}^{M} p ( j \vert i ) [ - log p ( j \vert i ) ] & ( 7 ) \\ & = & {\sum }_{i = 1}^{M} \frac{{c}_{1} ( i )}{n} {\sum }_{j - 1}^{M} \{ \frac{{c}_{2} ( i , j )}{{c}_{1} ( i )} [ - log \frac{{c}_{2} ( i , j )}{{c}_{1} ( i )} ] \} & \\ & = & \frac{1}{n} {\sum }_{i = 1}^{M} {\sum }_{j = 1}^{M} \{ {c}_{2} ( i , j ) [ - log \frac{{c}_{2} ( i , j )}{{c}_{1} ( i )} ] \} & ( 8 )\end{matrix}$$

However, it is assumed that 0 log 0=0. The above describes the chaos scale described in Non-Patent Document 1.

In response to the above chaos scale, the inventors proposed an index called a modified chaos scale and attempted to quantify the degree of chaos of time series data (see Patent Document 1). The modified chaos scale will be explained below. A mapping where τ is defined on a straight line, is set to

$$\begin{matrix}[ \# 5 ] & \\ τ : I \to I ⊂ {ℝ}^{1} & \end{matrix}$$

And for the initial value of ξ₀∈I

$${ξ}_{t} = τ ( {ξ}_{t - 1} ) = {τ}^{t} ( {ξ}_{0} ) ,$$

$$t = 1 , 2 , … , n$$

A total of n+1 time series data obtained by n iterations of is defined as

$$\{ {ξ}_{0} , {ξ}_{1} , {ξ}_{2} , … , {ξ}_{n} \}$$

And when the divided interval obtained by dividing the interval I including ξₜ into M equal parts is represented by Aᵢ (i=1, 2, . . . , M), and when the divided interval satisfies the following formula (1),

$$\begin{matrix}[ \# 6 ] & \\ I = {U}_{i = 1}^{M} {A}_{i} , & ( 1 )\end{matrix}$$

$${A}_{i} ⋂ {A}_{j} = ∅ ( i \neq j )$$

Calculate p(i), p(i, j), p(j|i) from c₁(i), c₂(i, j).

$${c}_{1} ( i ) = \# \{ {ξ}_{t} ∈ {A}_{i} \vert t = 0 , 1 , 2 , … , n - 1 \} \qquad ( 2 )$$

$${c}_{2} ( i , j ) = \# \{ {ξ}_{t} ∈ {A}_{i} , {ξ}_{t + 1} ∈ {A}_{j} \vert t = 0 , 1 , 2 , … , n - 1 \} \qquad ( 3 )$$

FIG. 1(a) shows the mapping area and section number of counter c₁(i), and FIG. 1(b) shows the mapping area and section number of counter c₂(i, j).

$$\begin{matrix}[ \# 7 ] & \\ p ( i ) = \frac{{c}_{1}^{( i )}}{n} & ( 4 )\end{matrix}$$

$$p ( i , j ) = \frac{{c}_{2}^{( i , j )}}{n} \qquad ( 5 )$$

$$p ( j \vert i ) = \frac{p ( i , j )}{p ( i )} = \frac{{c}_{2}^{( i , j )}}{{c}_{1}^{( i )}} \qquad ( 6 )$$

In the above, p(i) is the probability where ξₜ∈Aᵢ, p(i, j) is the probability where ξₜ∈Aᵢ, ξₜ+1∈Aⱼ, and p(j|i) is the conditional probability where ξₜ∈Aᵢ, ξₜ+1∈Aⱼ. Up to this point, it is the same as the chaos scale, and the following is unique to the modified chaos scale.

A subdivided section Bᵢ (i=1, 2, . . . , M×Q) is set by further dividing the divided section Aᵢ (i=1, 2, . . . , M) into Q equal parts. FIG. 2 shows the relationship between the divided sections Aᵢ and the subdivided sections Bᵢ in which actual data exists.

$$\begin{matrix}[ \# 8 ] & \\ I = {U}_{i = 1}^{M \times Q} {B}_{i} , & ( 9 )\end{matrix}$$

$${B}_{i} ⋂ {B}_{j} = ∅ ( i \neq j )$$

$$( {A}_{i} = {U}_{j - 1}^{Q} {B}_{( i - 1 ) Q + j} ) \qquad ( 10 )$$

This equation shows the relationship between the divided section Aᵢ (i=1, 2, . . . , M) and the subdivided section Bᵢ, which is further divided into Q equal parts.

When the measurement of the measured degree interval is set to 1 for the divided interval Aᵢ of the actual measured degree, the subdivided interval Bᵢ of the actual measured degree, and the subdivided interval, proportion q(i, j) occupied by subdivision interval Bᵢ of measurability in division interval is determined from the following c₃ (i, j), u₃ (i, j), and u₂ (i, j). This ratio q(i, j) is called a “norm ratio.”

$$\begin{matrix}[ \# 9 ] & \\ {c}_{3} ( i , j ) = \# \{ {ξ}_{t} ∈ {A}_{i} , {ξ}_{t} + 1 ∈ {B}_{j} \vert t = 0 , 1 , 2 , \cdot , n - 1 \} & ( 10 )\end{matrix}$$

$${u}_{3} ( i , j ) = \{ \begin{matrix}0 ( {c}_{3} ( i , j ) = 0 ) \\ 1 ( {c}_{3} ( i , j ) \geq 1 )\end{matrix} \qquad ( 11 )$$

$${u}_{2} ( i , j ) = {\sum }_{k = 1}^{Q} {u}_{3} ( i , ( j - 1 ) Q + k ) \qquad ( 12 )$$

$$q ( i , j ) = \{ \begin{matrix}0 ( {u}_{2} ( i , j ) = 0 ) \\ \frac{{u}_{2} ( i , j )}{Q} ( {u}_{2} ( i , j ) \geq 1 )\end{matrix} \qquad ( 13 )$$

The modified chaos measure H* is obtained as a formula shown in formula (16) for the following definition formula (14).

$$\begin{matrix}[ \#10 ] & \\ {H}^{*} = {\sum }_{i = 1}^{M} p ( i ) {\sum }_{j = 1}^{M} p ( j \vert i ) \{ [ - log p ( j \vert i ) ] - [ - log q ( i , j ) ] \} & ( 14 )\end{matrix}$$

$$= {\sum }_{i = 1}^{M} \frac{{c}_{1} ( i )}{n} {\sum }_{j = 1}^{M} \{ \frac{{c}_{2} ( i , j )}{{c}_{1} ( i )} \{ [ - log \frac{{c}_{2} ( i , j )}{{c}_{1} ( i )} ] - [ - log \frac{{u}_{2} ( i , j )}{Q} ] \} \} \qquad ( 15 )$$

$$= \frac{1}{n} {\sum }_{i = 1}^{M} {\sum }_{j = 1}^{M} \{ {c}_{2} ( i , j ) \{ [ - log \frac{{c}_{2} ( i , j )}{{c}_{1} ( i )} ] - [ - log \frac{{u}_{2} ( i , j )}{Q} ] \} \} \qquad ( 16 )$$

When comparing the formula for calculating the chaos measure H above and the formula for calculating the modified chaos measure H*, it can be seen that the calculation formula for calculating the modified chaos measure H* is the calculation formula for calculating the chaos measure H with the addition of

$$\begin{matrix}[ \# 11 ] & \\ - log \frac{{u}_{2} ( i , j )}{Q} & ( 17 )\end{matrix}$$

The above is a description of the modified chaos measure described in Patent Document 1.

Furthermore, the inventors provided the method described in Patent Document 2 and the method described in Patent Document 3 as a method for quantifying the degree of chaos of time-series data. The method described in Patent Document 2 introduces subdivision intervals (M×Q division) as in the case of the modified chaos measure, and calculates the division entropy in units of subdivision. While in the case of modified chaos scale, equation (17) is added, in the method described in Patent Document 2.

$$\begin{matrix}[ \#12 ] & \\ - logQ & ( 18 )\end{matrix}$$

Is added. Further, the method described in Patent Document 2 is characterized by a simple calculation algorithm, and has almost the same performance as the modified chaos measure method.

The method described in Patent Document 3 introduces subdivision intervals (M×Q division) as in the case of the modified chaos measure, and calculates the division entropy in units of subdivision. Furthermore, in order to make the data density constant, and to correct the magnification after mapping, the average of entropy in the case of outer measure and inner measure is used.

### PRIOR ART DOCUMENTS

### Non-Patent Documents

[Non-patent Document 1] Masanori Oya, Toshihide Hara, “Basics of Mathematical Physics and Mathematical Information,” Kindai Kagakusha, 2016

### Patent Documents

[Patent Document 1] JP-A-2021-64323
[Patent Document 2] JP-A-2021-64324
[Patent Document 3] JP-A-2022-7775

### SUMMARY OF THE INVENTION

### Problem to be Solved by the Invention

Although the conventional method described above makes it possible to obtain a curve that approximates the Lyapunov exponent and improve accuracy, it is necessary to increase the number of data and the number of divisions. The purpose of the present invention is to provide a time-series data evaluation device, a time-series data evaluation program, and a time-series data evaluation device capable of achieving high accuracy and high processing speed, and quantifying the degree of chaos in real time for real-time data. The object of the present invention is to provide a method for evaluating series data.

### Means to Solve the Problem

The time series data evaluation device according to the embodiment of the present invention is characterized by a mapping where τ is defined on a straight line, is set to

$$\begin{matrix}[ \#13 ] & \\ τ : I \to I ⊂ {1}^{} & \end{matrix}$$

And for the initial value of ξ₀∈I

$${{ξ}_{t}}_{{=}^{}} T ( {ξ}_{t - 1} ) = {T}^{t} ( {ξ}_{0} ) , t = 1 , 2 , … , n$$

A total of n+1 time series data obtained by n iterations of is defined as

$$\{ {ξ}_{0} , {ξ}_{1} , {ξ}_{2} , … , {ξ}_{n} \}$$

And when the divided interval obtained by dividing the interval I including ξₜ into M equal parts is represented by Aᵢ (i=1, 2, . . . , M), and when the divided interval satisfies the following formula (1),

$$\begin{matrix}[ \# 14 ] & \\ I = {⋃}_{i = 1}^{M} {A}_{i} , {A}_{i} ⋂ {A}_{j} = ∅ ( i \neq j ) & ( 1 )\end{matrix}$$

And let c₁(i) and p(i) be the following equations (2) and (4),

$$\begin{matrix}[ \#15 ] & \\ {c}_{1} ( i ) = \# \{ {ξ}_{t} ∈ {A}_{i} \vert t = 0 , 1 , 2 , … , n - 1 \} & ( 2 )\end{matrix}$$

$$p ( i ) = \frac{{c}_{1} ( i )}{n} \qquad ( 4 )$$

A probability calculation unit that calculates the probability p(i) that ξₜ∈Aᵢ, and setting a subdivision section Bᵢ (i=1, 2, . . . , M×Q) by further dividing the divided section Aᵢ (i=1, 2, . . . , M) into Q equal parts, and using a division entropy calculation unit that calculates division entropy using a measure in this subdivision interval, and a summation calculation unit that performs a summation calculation of the division interval range for the multiplication of the probability p(i) and the division entropy.

The time series data evaluation device according to the embodiment of the present invention is characterized in that the division entropy calculation unit includes an outer measure entropy calculation unit that calculates an outer measure entropy using an outer measure in the subdivision interval.

The time series data evaluation device according to the embodiment of the present invention is characterized in that the division entropy calculation unit includes an internal degree entropy calculation unit that calculates an internal degree entropy using the internal degree entropy in the subdivision interval.

In the time series data evaluation device according to the embodiment of the present invention, the division entropy calculation unit uses an average value of the outer measure entropy and the inner measure entropy as the partition entropy in the summation calculation.

In the time series data evaluation device according to the embodiment of the present invention, it is characterized by the fact that the pre-mapping subdivision interval Cᵢ (i=1, . . . , M) is further divided into W equal parts into the pre-mapping subdivision interval Cᵢ (i=1, 2, . . . , M×W), the number of pre-mapping subdivision intervals in which real data exists is vᵢ, and the actual data existence rate in the pre-mapping subdivision interval is equipped with an actual data existence rate calculation unit that calculates wᵢ by wᵢ=vᵢ/W; and the division entropy calculation unit creates a corrected outer measure entropy and a corrected inner measure entropy by correcting the outer measure entropy and the inner measure entropy by the actual data existence rate wᵢ, and calculates the corrected outer measure entropy and the corrected inner measure, and the average value with the entropy is used as the division entropy in the summation calculation.

### BRIEF EXPLANATIONS OF THE FIGURES

FIG. 1 This is an explanatory diagram showing an example of the relationship between division intervals and subdivision intervals used in the embodiment of the present invention and interval numbers in mapping.

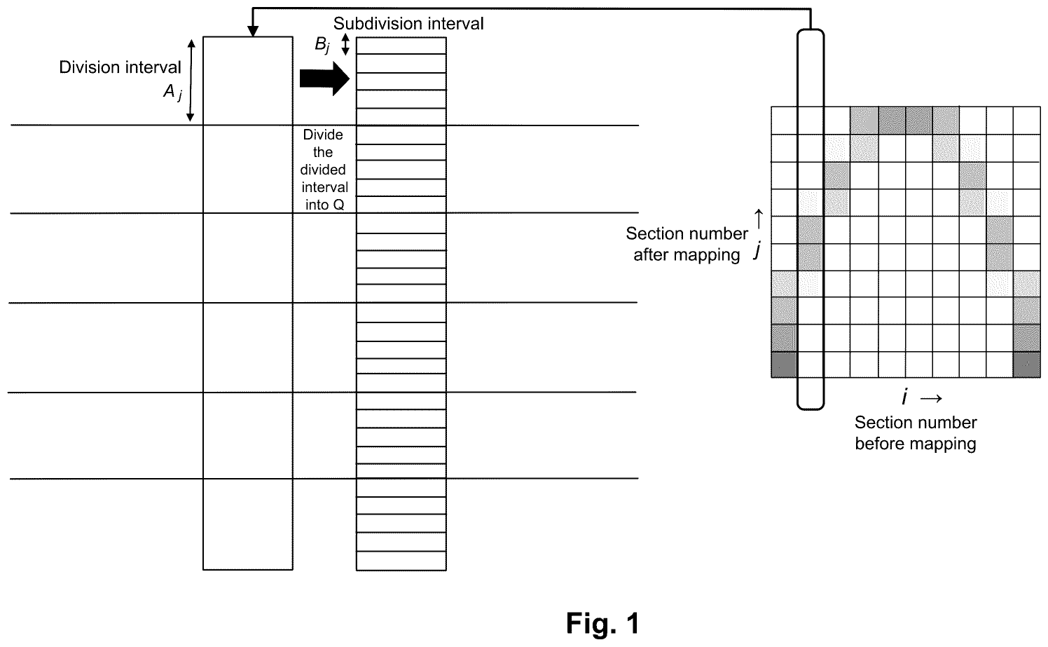

FIG. 2 This is an explanatory diagram showing an example of the relationship between a divided section Aᵢ used in the embodiment of the present invention and a subdivided section Bᵢ in which actual data exists.

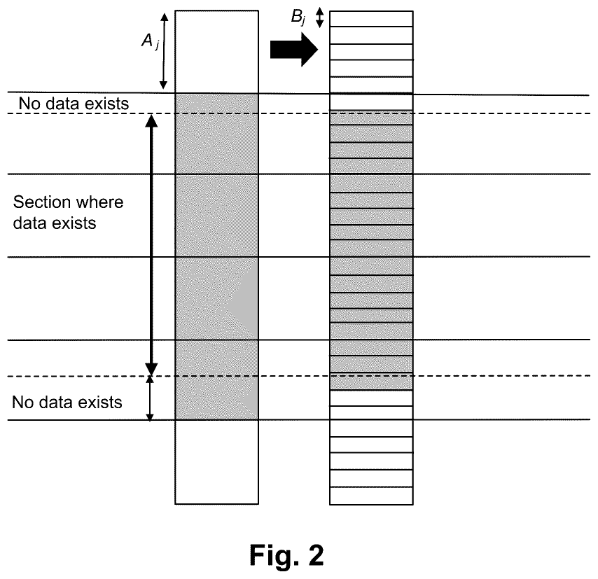

FIG. 3 This is an explanatory diagram illustrating an example of a measured degree division interval Aᵢ, an actual measurement degree subdivision interval Bᵢ, and a case where the measure of the measured degree interval is set to 1 for the subdivision interval, which are used in the embodiment of the present invention.

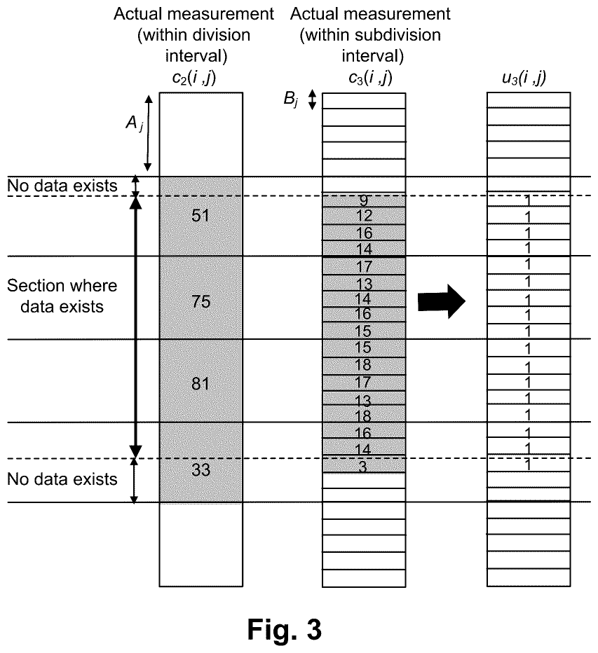

FIG. 4 This is a block diagram of a time-series data evaluation device according to an embodiment of the present invention.

FIG. 5 This is a block diagram of a calculation unit etc. that performs various calculations realized by executing the time-series data evaluation program stored in the external storage device 104 of FIG. 4.

FIG. 6 An explanatory diagram of the distribution ratio (entropy) of the measure used in the chaos scale.

FIG. 7 An explanatory diagram of the “norm expansion rate” used in the Lyapunov exponent.

FIG. 8 This is an explanatory diagram showing the magnification rate by mapping when the measure of the measurable degree section is set to 1 for the subdivision section in the embodiment of the present invention.

FIG. 9 An explanatory diagram when performing post-mapping correction using an external measure in an embodiment of the present invention.

FIG. 10 An explanatory diagram when performing post-mapping correction using internal measure in the embodiment of the present invention.

FIG. 11 A diagram illustrating an improvement in the method for estimating the enlargement rate of an interval before mapping in the embodiment of the present invention.

FIG. 12 This is a graph showing changes in evaluation values that are the calculation results when using the high-precision chaotic scale function H″ according to the present embodiment and a diagram showing a graph when using the Lyapunov exponent, where the number of divisions M=8, the number of subdivisions Q=6, the number of pre-mapping subdivisions W=6 and the number of data n=1000.

FIG. 13 This is a graph showing changes in evaluation values that are the calculation results when using the high-precision chaotic scale function H″ according to the present embodiment and a diagram showing a graph when using the Lyapunov exponent, where the number of divisions M=10, the number of subdivisions Q=8, the number of pre-mapping subdivisions W=8 and the number of data n=2000.

FIG. 14 This is a graph showing changes in evaluation values that are the calculation results when using the high-precision chaotic scale function H″ according to the present embodiment and a diagram showing a graph when using the Lyapunov exponent, where the number of divisions M=16, the number of subdivisions Q=16, the number of pre-mapping subdivisions W=16 and the number of data n=10,000.

FIG. 15 This is a graph showing changes in evaluation values that are the calculation results when using the high-precision chaotic scale function H″ according to the present embodiment and a diagram showing a graph when using the Lyapunov exponent, where the number of divisions M=32, the number of subdivisions Q=32, the number of pre-mapping subdivisions W=32 and the number of data n=50,000.

### DESCRIPTION OF THE PREFERRED EMBODIMENTS

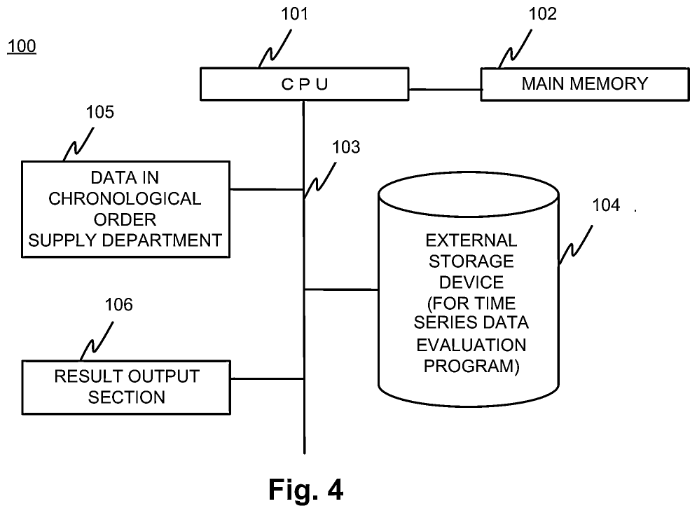

A time-series data evaluation device, a time-series data evaluation program, and a time-series data evaluation method according to embodiments of the present invention will be described below with reference to the accompanying drawings. In each figure, the same components are given the same reference numerals and redundant explanations will be omitted. FIG. 4 shows a block diagram of the time series data evaluation device 100 according to the embodiment. The time series data evaluation device 100 can be configured by a cloud computer, a server computer, a personal computer, or other computer.

In the time-series data evaluation device 100, a CPU 101 performs calculations based on programs and data stored in a main memory 102. An external storage device 104 is connected to the CPU 101 via a bus 103, and a time-series data evaluation program is stored in the external storage device 104. As the CPU 101 reads a time-series data evaluation program from the external storage device 104 to the main memory 102, this program is executed, functioning as time series data evaluation device 100, the time series data evaluation method is executed during this operation,

In addition to the external storage device 104, a time-series data supply section 105 is connected to the bus 103. The time-series data supply unit 105 can capture and hold time-series data from an external sensor in real time or may calculate time-series data or mappings collected by some external device. Further, the device may be capable of holding and supplying time-series data by setting a medium storing collected time-series data. Furthermore, it may include all of the above configurations. In any case, when the CPU 101 executes the time-series data evaluation program to evaluate time-series data, the time-series data is supplied from the time-series data supply unit 105.

A result output unit 106 is connected to the bus 103. The result output unit 106 can be a device that outputs the results processed by the time series data evaluation device 100, such as a display device or a printer. Further, the result output unit 106 may be a medium that stores the results of processing in the time-series data evaluation device 100, and may also be a device that transmits the processing results to the processing requester (client) via a line or the like.

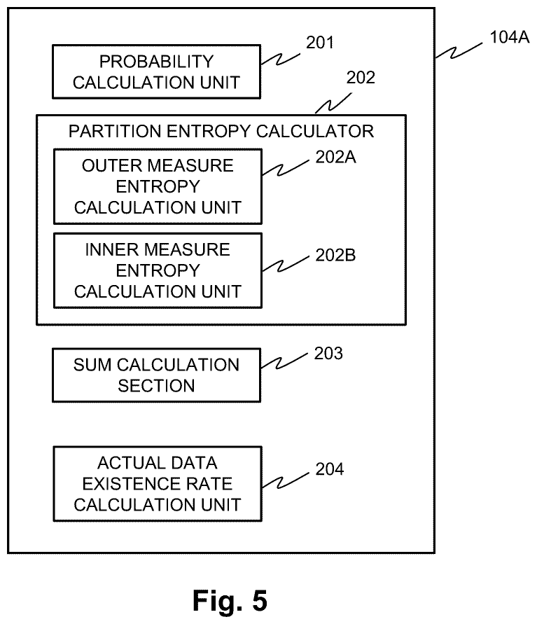

By executing the time-series data evaluation program 104A stored in the external storage device 104, a calculation unit and the like that perform the various calculations shown in FIG. 5 are realized. That is, as shown in FIG. 5, the time series data evaluation device 100 includes a probability calculation section 201, a division entropy calculation section 202, a summation calculation section 203, and an actual data existence rate calculation section 204. The division entropy calculation section 202 includes an outer measure entropy calculation section 202A and an inner measure entropy calculation section 202B.

In the time-series data evaluation device 100 of this embodiment, as explained below, by comparing the conventionally known chaos scale or modified chaos scale with the Lyapunov exponent, it is possible to approach the viewpoint of the Lyapunov exponent with high accuracy and processing speed. It was concluded that this method can speed up the process and move forward to quantifying the degree of chaos in real-time using real-time data. Hereinafter, along with the theory of the process of reaching this conclusion, the calculation unit, etc. that performs each calculation etc. provided in the time-series data evaluation device 100 of this embodiment will be explained.

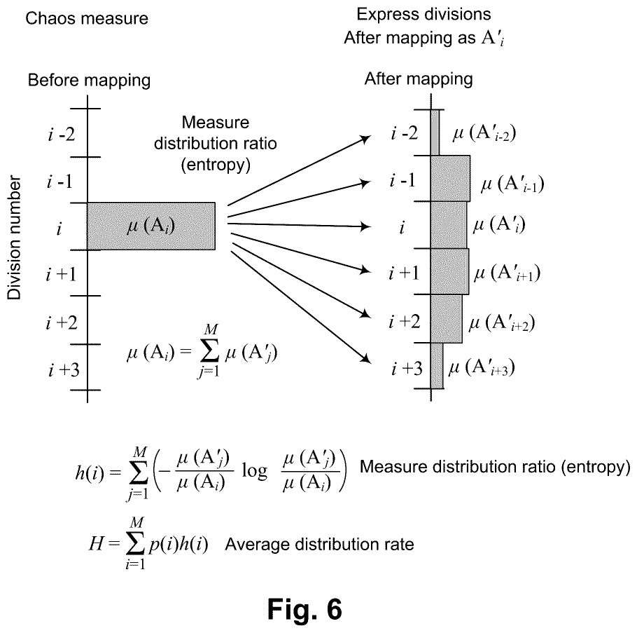

The inventors of the present invention studied the chaos scale and Lyapunov exponent described above and found that the chaos scale uses the distribution ratio (entropy) of the measure, as shown in FIG. 6. Thus, for

$$\begin{matrix}[ \# 16 ] & \\ μ ( {A}_{i} ) = {\sum }_{i = 1}^{M} μ ( ( {A}_{j}^{′} ) ) , & \end{matrix}$$

it is

$$\begin{matrix}[ \# 17 ] & \\ h ( i ) = {\sum }_{j = 1}^{M} ( - \frac{μ ( {A}_{j}^{′} )}{μ ( {A}_{i}^{′} )} log \frac{μ ( {A}_{j}^{′} )}{μ ( {A}_{i}^{′} )} ) & \end{matrix}$$

measure distribution ratio (entropy),

### And

$$\begin{matrix}[ \#18 ] & \\ H = {\sum }_{i = 1}^{M} p ( i ) h ( i ) … average distribution ratio & \end{matrix}$$

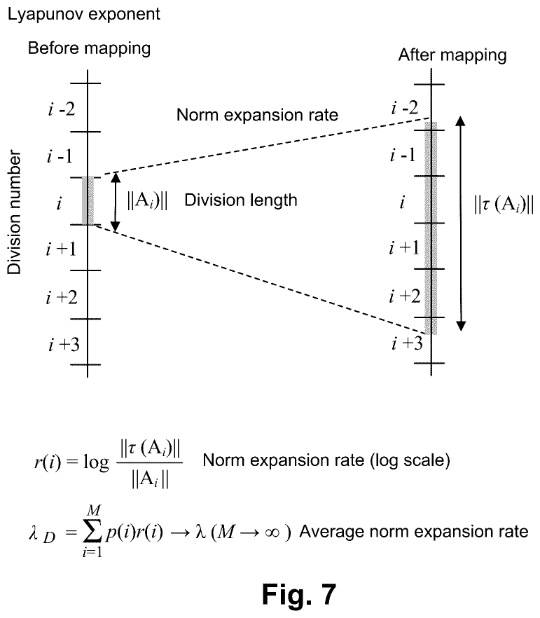

On the other hand, in the Lyapunov exponent, a “norm expansion rate” is used, as shown in FIG. 7. Thus,

$$\begin{matrix}[ \# 19 ] & \\ r ( i ) = log \frac{‖ τ ( {A}_{i} ) ‖}{‖ {A}_{i} ‖} … norm expansion rate ( log scale ) & \end{matrix}$$

$${λ}_{D} = {\sum }_{i = 1}^{M} p ( i ) r ( i ) \to λ ( M \to ∞ ) … average expansion rate$$

In view of the above, this embodiment adopts a configuration in which processing is performed from the perspective of changing from the measure distribution rate to the norm expansion rate.

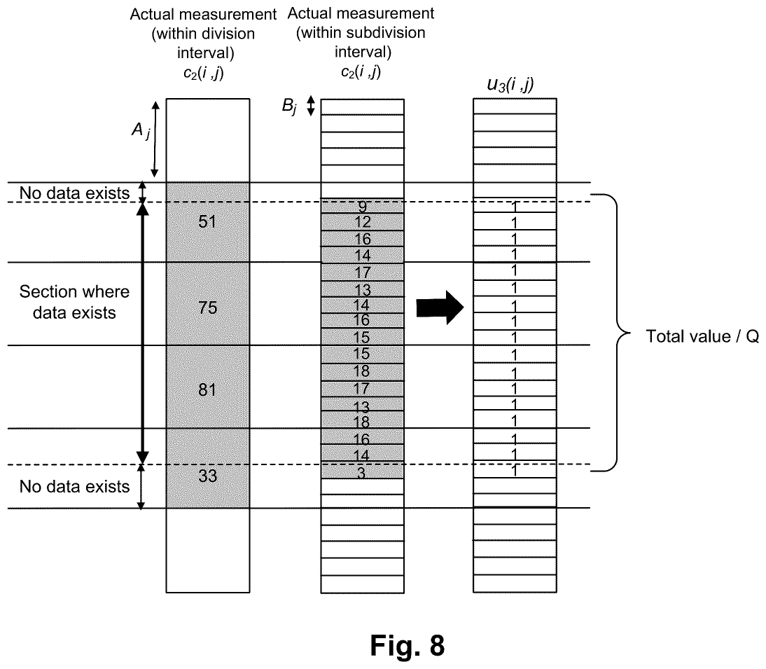

The above-mentioned change in perspective from “measure distribution rate to norm expansion rate” involves dividing the divided interval into sub-divided intervals and changing the measure of the measurable interval of the sub-divided interval to 1, as shown in FIG. 8. This is achieved by calculating the “total value/Q” as an enlargement rate by mapping in the section.

This embodiment provides a time-series data evaluation device that can achieve higher accuracy and faster processing speed by further modifying the chaos measure H and the modified chaos measure H* described above. Therefore, the formula for defining the chaos scale is shown in formula (7), and the formula for defining the modified chaos scale is shown in formula (14), and these will be compared.

$$\begin{matrix}[ \# 20 ] & \\ H = {\sum }_{i = 1}^{M} p ( i ) {\sum }_{j = 1}^{M} p ( j \vert i ) [ - log p ( j \vert i ) ] & ( 7 )\end{matrix}$$

$${H}^{*} = {\sum }_{j = 1}^{M} p ( i ) {\sum }_{j = 1}^{M} p ( j \vert i ) \{ [ - log p ( j \vert i ) ] - [ - log q ( i , j ) ] \} \qquad ( 14 )$$

Both have a probability calculation unit that calculates the probability p(i) that ξₜ∈Aᵢ. Then calculate per equation (60),

$$\begin{matrix}[ \#21 ] & \\ {\sum }_{i = 1}^{M} p ( i ) & ( 60 )\end{matrix}$$

The formula for the chaos scale H has the following formula (61) following the above formula (60), and the formula for the modified chaos scale H* has the following formula (62).

$$\begin{matrix}[ \#22 ] & \\ {\sum }_{j = 1}^{M} p ( j \vert i ) [ - log p ( j \vert i ) ] & ( 61 )\end{matrix}$$

$${\sum }_{j = 1}^{M} p ( j \vert i ) \{ [ - log p ( j \vert i ) ] - [ - log q ( i , j ) ] \} \qquad ( 62 )$$

Since the above equations (61) and (62) can be considered as entropy in information, they are collectively referred to as “division entropy”, and are expressed by <h>, which is the time series that is intended to be realized in this embodiment.
Let the function type used by the data evaluation device be a high-precision chaotic scale function H″, and it can be written as

$$\begin{matrix}[ \#23 ] & \\ {H}^{″} = {\sum }_{i = 1}^{M} p ( i ) \cdot < h > & ( 63 )\end{matrix}$$

In the embodiment, this high-precision chaotic scale function H″ is obtained, and as described below, the divided interval Aᵢ (i=1, 2, . . . , M) is further divided into Q equal parts. A division entropy calculation unit 202 that sets a division interval Bᵢ (i=1, 2, . . . , M×Q) and calculates division entropy using the measure in this subdivision interval, and the above probability p(i). and a summation calculation unit 203 that performs a summation calculation of the divisional interval range regarding the multiplication of the divisional entropy.

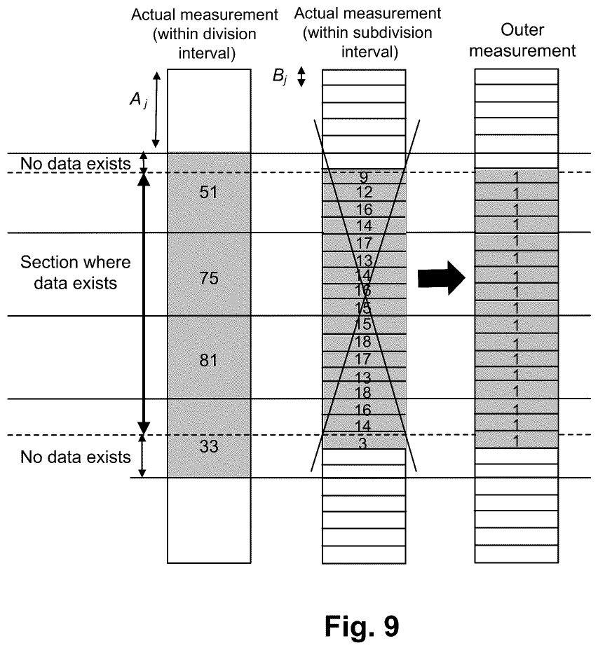

In order to obtain the high-precision chaotic scale function H″, this embodiment, as shown in FIG. 9, divides the divided interval into subdivided intervals, change the measure of the measurable interval of the subdivided interval to 1, and perform post-mapping correction using the outer measure. The proportion q′_{O} (i, j) of the subdivision interval Bᵢ of the outer measure in the division interval Aᵢ is determined from the following u_{3O} (i, j), u_{2O} (i, j), u_{1O} (i, j), p′_{O}(i, j).

$$\begin{matrix}[ \# 24 ] & \\ {u}_{3 O} ( i , j ) = \{ \begin{matrix}0 & ( {c}_{3} ( i , j ) = 0 ) \\ 1 & ( {c}_{3} ( i , j ) \geq 1 )\end{matrix} & ( 23 )\end{matrix}$$

$${u}_{2 O} ( i , j ) = {\sum }_{k = 1}^{Q} {u}_{3 O} ( i , ( j - 1 ) Q + k ) \qquad ( 24 )$$

$${u}_{1 O} = {\sum }_{j = 1}^{M} {u}_{2 O} ( i , j ) \qquad ( 25 )$$

$${p}_{O}^{′} ( j \vert i ) = \{ \begin{matrix}0 ( {u}_{1 O} ( i , j ) = 0 ) \\ \frac{{u}_{2 O} ( i , j )}{{u}_{1 O ( i )}} ( {u}_{1 O} ( i , j ) \geq 1 )\end{matrix} \qquad ( 26 )$$

$${q}_{O}^{′} ( i , j ) = \frac{{u}_{2 O ( i , j )}}{Q} ( {u}_{2 O} ( i , j ) \geq 1 ) \qquad ( 27 )$$

Using the above q′_{O}(i, j) and p′_{O}(i, j), find the entropy h′_{O}(i) of the outer measure

$${h}_{O}^{′} ( i ) = {\sum }_{j = 1}^{M} {p}_{O}^{′} ( j \vert i ) \{ [ - log {p}_{O}^{′} ( j \vert i ) ] - [ - log {q}_{O}^{′} ( i , j ) ] \} \qquad [ \#25 ]$$

High-precision chaotic scale function <H′_{O}> using only external measures is

$$< {H}_{O}^{′} > = {\sum }_{i = 1}^{M} p ( i ) {h}_{O}^{′} ( i ) \qquad [ \#26 ]$$

In this way, the division entropy calculation section 202 includes an outer measure entropy calculation section 202A that calculates outer measure entropy using the outer measure in the subdivision section.

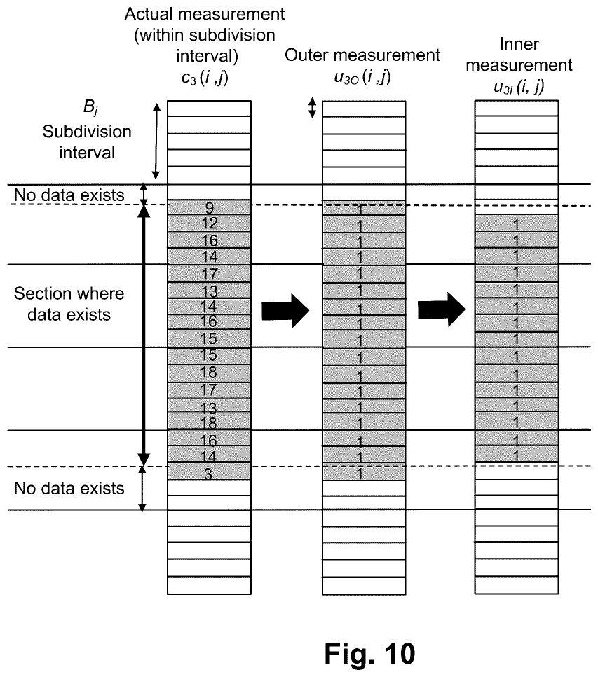

Furthermore, in this embodiment, as shown in FIG. 10, the divided section is divided into sub-divided sections, and the measure of the measurable degree section of the subdivision section is changed to 1, and post-mapping correction using the inner measure is performed. The proportion q′_{I} (i, j) of the subdivision interval Bᵢ of the inner measure in the division interval Aᵢ is. determined by the following u_{3I} (i, j), u_{2I} (i, j), u_{1I} (i, j), and p′_{I} (i, j).

$$\begin{matrix}[ \# 27 ] & \\ {u}_{3 I} ( i , j ) = \{ \begin{matrix}1 & ( if {u}_{3 O} ( i , 1 ) = {u}_{3 O} ( i , 2 ) = 1 \\ & else if {u}_{3 O} ( i , MQ ) = {u}_{3 O} ( i , MQ - 1 ) = 1 \\ & else if 2 \leq j \leq MQ - 1 AND \\ & {u}_{3 O} ( i , j - 1 ) = {u}_{3 O} ( i , j ) = {u}_{3 O} ( i , j + 1 ) = 1 ) \\ 0 & ( otherwise )\end{matrix} & ( 28 )\end{matrix}$$

$$\begin{matrix}[ \# 28 ] & \\ {u}_{2 I} ( i , j ) = {\sum }_{k = 1}^{Q} {u}_{3 I} ( i , ( j - 1 ) Q + k ) & ( 29 )\end{matrix}$$

$${u}_{1 I} = {\sum }_{j = 1}^{M} {u}_{2 I} ( i , j ) \qquad ( 30 )$$

$${p}_{I}^{′} ( j \vert i ) = \{ \begin{matrix}0 ( {u}_{1 I} ( i , j ) = 0 \\ \frac{{u}_{2 I} ( i , j )}{{u}_{1 I ( i )}} ( {u}_{1 I} ( i , j ) \geq 1 )\end{matrix} \qquad ( 31 )$$

$${q}_{I}^{′} ( i , j ) = \frac{{u}_{2 I ( i , j )}}{Q} ( {u}_{2 I} ( i , j ) \geq 1 ) \qquad ( 32 )$$

Using the above q′_{I} (i, j) and p′_{I} (i, j), find the entropy h′_{I} (i) of the inner measure as shown below

$${h}_{I}^{′} ( i ) = {\sum }_{j = 1}^{M} {p}_{I}^{′} ( j \vert i ) \{ [ - log {p}_{I}^{′} ( j \vert i ) ] - [ - log {q}_{I}^{′} ( i , j ) ] \} \qquad [ \# 29 ]$$

In this way, the division entropy calculation unit 202 includes an internal measure entropy calculation unit 202B that calculates the internal measure entropy using the internal measure in the subdivision section.
High-precision chaotic scale function using only internal measure <H′I> is

$$< {H}_{i}^{′} > = {\sum }_{i = 1}^{M} p ( i ) {h}_{I}^{′} ( i ) \qquad [ \# 30 ]$$

Entropy of external measure h′_{O}(i) is
[#31]
Based on formulas 26 and 27, the outer measurement entropy h′_{O}(i) is

$$\begin{matrix}{h}_{O}^{′} ( i ) = {\sum }_{j = 1}^{M} {p}_{O}^{′} ( j \vert i ) \{ [ - log {p}_{O}^{′} ( j \vert i ) ] - [ - log {q}_{O}^{′} ( i , j ) ] \} \\ = {\sum }_{j = 1}^{M} \{ \frac{{u}_{2 O} ( i , j )}{{u}_{1 O} ( i )} \{ [ - log \frac{{u}_{2 O} ( i , j )}{{u}_{1 O} ( i )} ] - [ - log \frac{{u}_{2 O} ( i , j )}{Q} ] \} \} \\ = {\sum }_{j = 1}^{M} \{ \frac{{u}_{2 O} ( i , j )}{{u}_{1 O} ( i )} [ - log \frac{Q}{{u}_{1 O} ( i )} ] \} \\ = \frac{1}{{u}_{1 O} ( i )} [ - log \frac{Q}{{u}_{1 O} ( i )} ] {\sum }_{j = 1}^{M} {u}_{2 O} ( i , j ) \\ = - log \frac{Q}{{u}_{1 O} ( i )}\end{matrix}$$

Entropy of internal measure h′_{I}(i) is
[#32]
Based on formulas 31 and 32, the inner measurement entropy h′_{I}(i) is

$$\begin{matrix}{h}_{I}^{′} ( i ) = {\sum }_{j = 1}^{M} {p}_{I}^{′} ( j \vert i ) \{ [ - log {p}_{I}^{′} ( j \vert i ) ] - [ - log {q}_{I}^{′} ( i , j ) ] \} \\ = {\sum }_{j = 1}^{M} \{ \frac{{u}_{2 I} ( i , j )}{{u}_{1 I} ( i )} \{ [ - log \frac{{u}_{2 I} ( i , j )}{{u}_{1 I} ( i )} ] - [ - log \frac{{u}_{2 I} ( i , j )}{Q} ] \} \} \\ = {\sum }_{i = 1}^{M} {\sum }_{j = 1}^{M} \{ \frac{{u}_{2 I} ( i , j )}{{u}_{1 I} ( i )} [ - log \frac{Q}{{u}_{1 I} ( i )} ] \} \\ = \frac{1}{{u}_{1 I} ( i )} [ - log \frac{Q}{{u}_{1 I} ( i )} ] {\sum }_{j = 1}^{M} {u}_{2 I} ( i , j ) \\ = - log \frac{Q}{{u}_{1 I} ( i )}\end{matrix} \qquad ( 34 )$$

In this embodiment, the new entropy h′(i) is the average value of the entropy h′O(i) of the outer measure and the entropy h′i(i) of the inner measure as shown below:

$$\begin{matrix}[ \# 33 ] & \\ \begin{matrix}{h}^{′} ( i ) = \frac{{h}_{O}^{′} ( i ) + {h}_{I}^{′} ( i )}{2} \\ = \frac{1}{2} \{ [ - log \frac{Q}{{u}_{1 O} ( i )} ] + [ - log \frac{Q}{{u}_{1 I} ( i )} ] \}\end{matrix} & ( 35 )\end{matrix}$$

Further, the high-precision chaotic scale function H′ using only post-mapping correction is

$$\begin{matrix}[ \# 34 ] & \\ \begin{matrix}{H}^{′} = {\sum }_{i = 1}^{M} p ( i ) {h}^{′} ( i ) \\ = {\sum }_{i = 1}^{M} \frac{{c}_{1} ( i )}{n} \frac{1}{2} \{ [ - log \frac{Q}{{u}_{1 O} ( i )} ] + [ - log \frac{Q}{{u}_{1 I} ( i )} ] \} \\ = \frac{1}{2 n} {\sum }_{i = 1}^{M} {c}_{1} ( i ) \{ [ - log \frac{Q}{{u}_{1 O} ( i )} ] + [ - log \frac{Q}{{u}_{1 I} ( i )} ] \}\end{matrix} & ( 36 )\end{matrix}$$

As shown, the division entropy calculation unit 202 according to the present embodiment uses the average value of the outer measure entropy and the inner measure entropy as the partition entropy in the summation calculation.

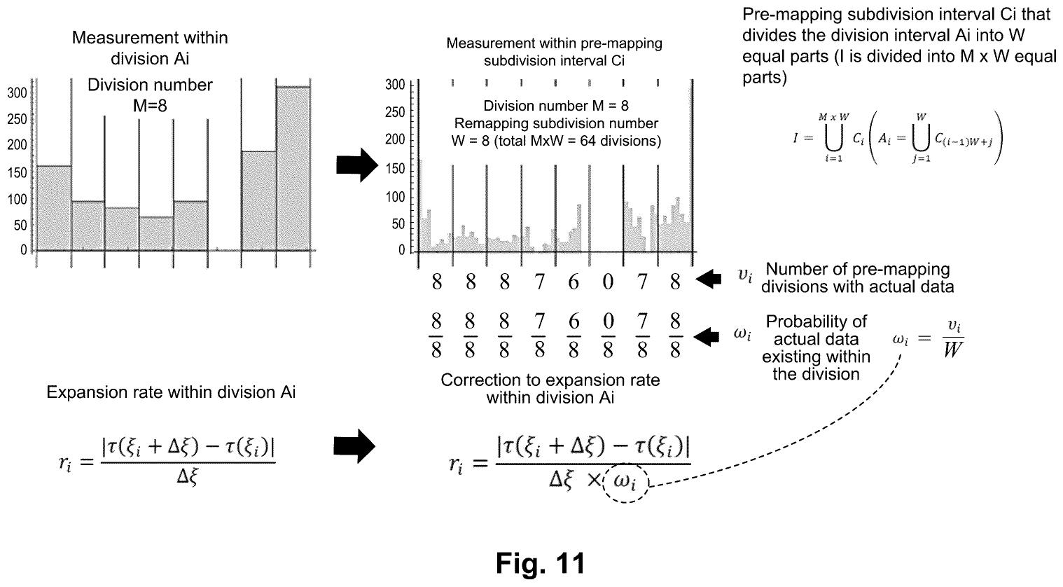

In this embodiment, the method for estimating the enlargement rate of the pre-mapping section is improved. As shown in FIG. 11(a), a pre-mapping subdivision interval Cᵢ is obtained by dividing a divided interval Aᵢ with the number of divisions M (here, 8) into W (here, 8) equal parts. is shown in FIG. 11(b). Therefore, the subdivision I is

$$I = {{⋃}^{M \times W}}_{i = 1} {C}_{i} ( {A}_{i} = {{⋃}^{W}}_{j = 1} {C}_{( i - 1 ) W + j} ) \qquad [ \# 35 ]$$

In the above, if the number of “pre-mapping subdivision sections” in which real data exists is vᵢ, and the real data existence rate within the divided sections is wᵢ, then the real data existence rate wᵢ=vᵢ/W. The actual data existence rate wᵢ is calculated as the ratio w(i) occupied by the pre-mapping subdivision interval of the measurability in the division interval Ai, as follows.

$${d}_{1} ( i ) = \# \{ {ξ}_{t} ∈ {C}_{i} \vert t = 0 , 1 , 2 , … , n - 1 \} \qquad ( 2 )$$

$${d}_{2} ( i ) = \{ \begin{matrix}0 & ( {d}_{1} ( i ) = 0 ) \\ 1 & ( {d}_{1} ( i ) \geq 1 )\end{matrix} \qquad [ \# 36 ]$$

$$v ( i ) = {\sum }_{j = 1}^{W} {d}_{2} ( ( i - 1 ) W + j )$$

$$w ( i ) = \frac{v ( i )}{W}$$

In this embodiment, as described above, for the pre-mapping subdivision interval Cᵢ (i=1, 2, . . . , M×W) obtained by further dividing the above division interval Aᵢ (i=1, 2, . . . , M) into W equal parts, and the number of pre-mapping subdivision sections in which real data exists is set as vᵢ, and the present invention includes a real data existence rate calculation unit 204 that calculates the real data presence rate wᵢ in the pre-mapping subdivision section by wᵢ=vᵢ/W.

The above mentioned entropy of equations (33) and (34) are

$$\begin{matrix}[ \# 37 ] & \\ {h}_{O}^{′} ( i ) = - log \frac{Q}{{u}_{1 O} ( i )} = log \frac{{u}_{1 O} ( i )}{Q} & ( 45 )\end{matrix}$$

$${h}_{I}^{′} ( i ) = - log \frac{Q}{{u}_{1 I} ( i )} = log \frac{{u}_{1 I} ( i )}{Q} \qquad ( 46 )$$

$$log \{ Norm expansion rate due to mapping τ \} = log \frac{‖ τ ( {A}_{i} ) ‖}{‖ {A}_{i} ‖}$$

After correcting the equations (45) and (46) using the above w(i),

$$log \{ \frac{{u}_{1 O} ( i )}{Q} \times \frac{W}{v ( i )} \} = - log \{ \frac{Q}{{u}_{1 O} ( i )} \times \frac{v ( i )}{W} \} {=}^{def} {h}_{o}^{″} \qquad [ \# 38 ]$$

$$log \{ \frac{{u}_{1 l} ( i )}{Q} \times \frac{W}{v ( i )} \} = - log \{ \frac{Q}{{u}_{1 l} ( i )} \times \frac{v ( i )}{W} \} {=}^{def} {h}_{l}^{″}$$

From the above, h″(i), the sum (average) of the entropy after mapping and the entropy before mapping is

$${h}^{″} ( i ) = \frac{{h}_{o}^{″} ( i ) + {h}_{l}^{″} ( i )}{2} \qquad [ \# 39 ]$$

$$= \frac{1}{2} \{ [ - log \frac{Q}{{u}_{1 O} ( i )} \times \frac{v ( i )}{W} ] + [ - log \frac{Q}{{u}_{1 l} ( i )} \times \frac{v ( i )}{W} ] \}$$

In the time-series data evaluation device of this embodiment, the division entropy calculation unit 202 finally calculates the high-precision chaotic measure function H″ as follows.

$${H}^{″} = {\sum }_{i = 1}^{M} \frac{{c}_{1} ( i )}{n} \frac{1}{2} \{ [ - log \frac{Q}{{u}_{1 O} ( i )} \times \frac{v ( i )}{W} ] + [ - log \frac{Q}{{u}_{1 l} ( i )} \times \frac{v ( i )}{W} ] \} \qquad [ \# 40 ]$$

$$= \frac{1}{2 n} {\sum }_{i = 1}^{M} {c}_{1} ( i ) \{ [ - log \frac{Q}{{u}_{1 O} ( i )} \times \frac{v ( i )}{W} ] + [ - log \frac{Q}{{u}_{1 l} ( i )} \times \frac{v ( i )}{W} ] \}$$

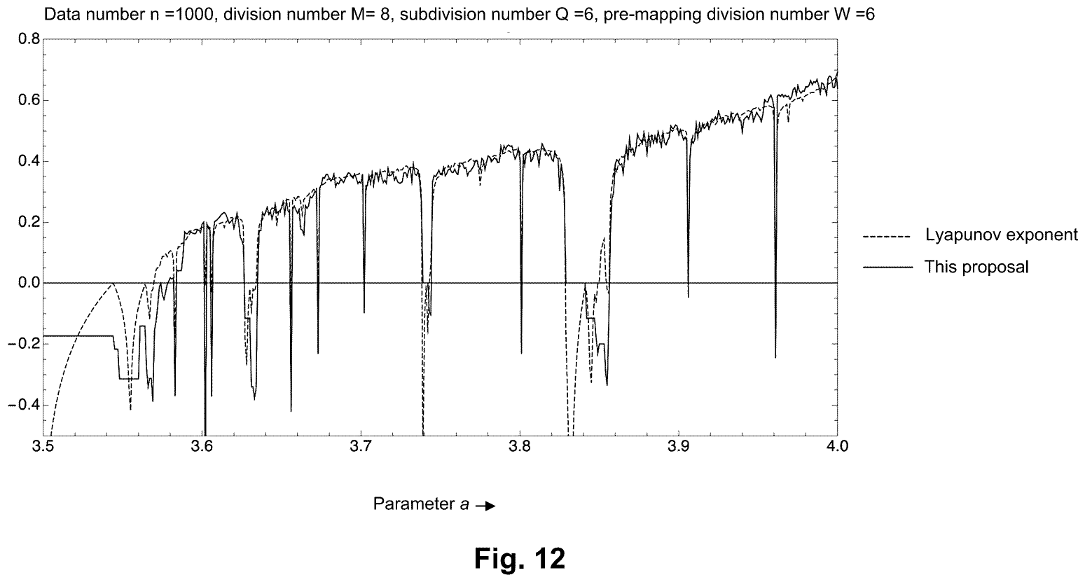

FIGS. 12 to 14 show changes in evaluation values that are the calculation results when using the high-precision chaotic scale function H″ according to the present embodiment, which is calculated as described above, and when using the Lyapunov exponent. In either case, it is based on a logistic mapping (a=3.5 to 4.0).

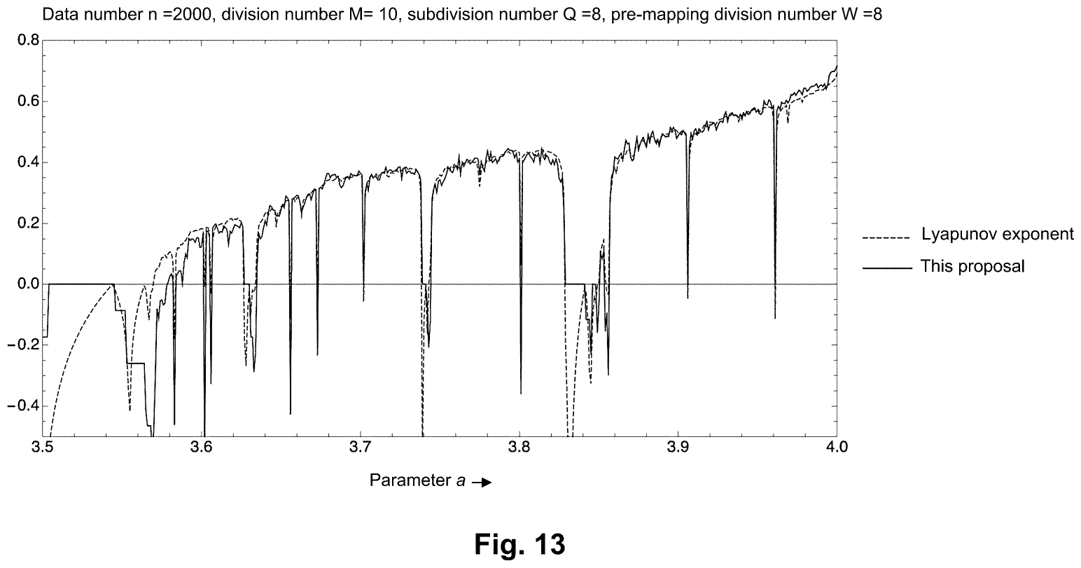

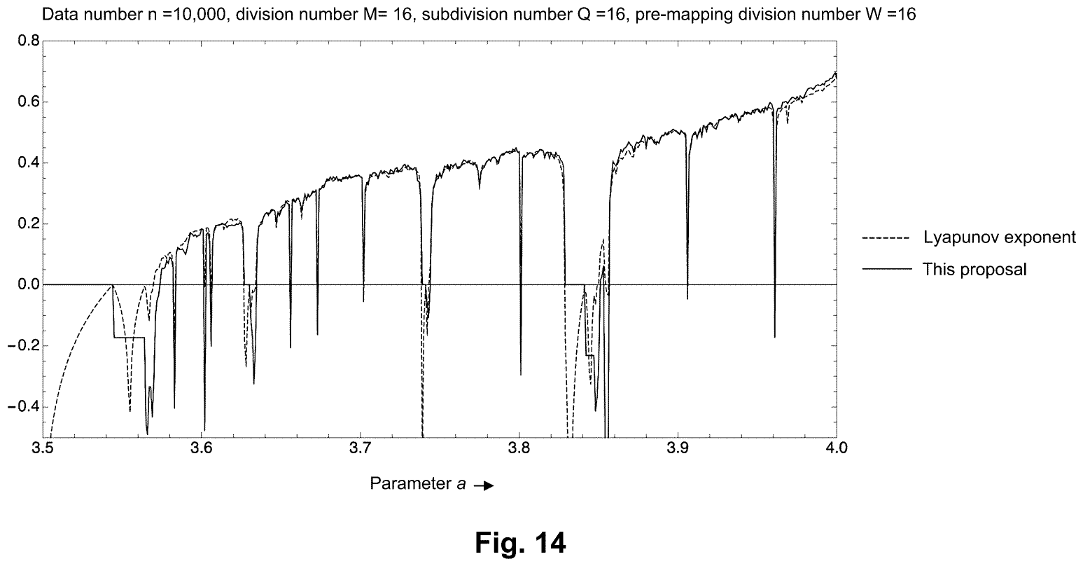

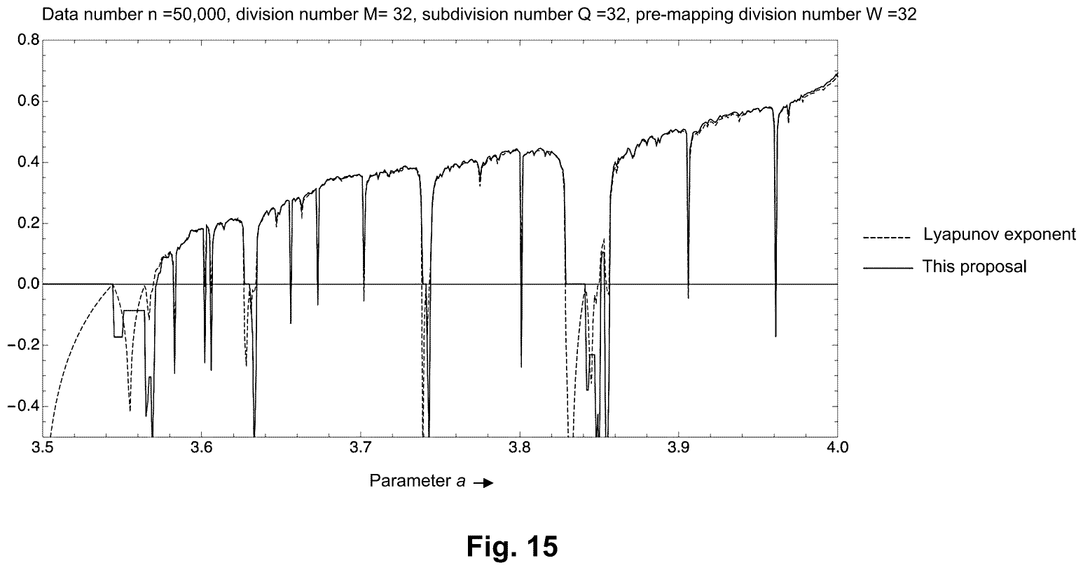

In FIG. 12, the number of divisions M=8, the number of subdivisions Q=6, the number of pre-mapping subdivisions W=6 and the number of data n=1000.
In FIG. 13, the number of divisions M=10, the number of subdivisions Q=8, the number of pre-mapping subdivisions W=8 and the number of data n=2000.
In FIG. 14, has the number of divisions M=16, the number of subdivisions Q=16, the number of pre-mapping subdivisions W=16 and the number of data n=10,000.
In FIG. 15, has the number of divisions M=32, the number of subdivisions Q=32, the number of pre-mapping subdivisions W=32 and the number of data n=50,000.

In this embodiment, even when the number of divisions and the number of data are small, it is possible to obtain an evaluation value that is very close to the Lyapunov exponent. In other words, in the method described in Patent Document 3, when the number of divisions is 80 and the number of data is 10,000,000, or when the number of divisions is 320 and the number of data is 1,000,000, it approaches the Lyapunov exponent but in this embodiment, it has been confirmed that the number of divisions is a one-digit number and the number of data is approximately 1000 to sufficiently approximate the Lyapunov exponent. This tendency was able to improve accuracy even in the mapping range where the Lyapunov exponent takes a small value (a=3.6 or so).

In the method described in Patent Document 3, unlike the invention according to the embodiment of the present application, no measure correction is performed before correction. Also in the method described in Patent Document 3, when the measure of the divided interval is a measurable measure, the measure is corrected by converting it to 1, otherwise it is 0, and the measure-corrected outer measure and the measure-corrected inner measure are used.

In this embodiment, in the method that applies only the measure transformation after mapping, a high-precision chaotic scale function H″ is obtained by using the outer measure entropy h″_{O} obtained by calculation using the corrected outer measure and the inner measure entropy h″ obtained by calculation using the corrected inner measure as new entropy h″(i).

In the method described in Patent Document 3, the outer measure data evaluation value H★ₒᵤₜ is calculated by calculation using the corrected outer measure as the measure, and the inner measure data evaluation value H★ᵢₙₙ is calculated by calculation using the corrected inner measure as the measure. Then calculate these average values as the final evaluation value H★. The formula for calculating the evaluation value H★ is written in accordance with the format adopted in this embodiment as follows.

$$[ \# 41 ]$$

$${c}_{3 l} ( i , j ) = {c}_{3} ( i , j ) \times {u}_{3 l} ( i , J ) \qquad ( 51 )$$

$${c}_{2 l} ( i , j ) = {\sum }_{k = 1}^{Q} {c}_{3 l} ( i , ( j - 1 ) Q + k ) \qquad ( 52 )$$

$${c}_{1 l} ( i ) = {\sum }_{j = 1}^{M} {c}_{2 l} ( i , j ) \qquad ( 53 )$$

$${n}_{l} = {\sum }_{j = 1}^{M} {c}_{1 l} ( i ) \qquad ( 54 )$$

$${H}_{out}^{*} = \frac{1}{n} {\sum }_{i = 1}^{M} {c}_{1} ( i ) [ - log \frac{Q}{{u}_{1 O} ( i )} ] \qquad ( 55 )$$

$${H}_{inn}^{*} = \frac{1}{{n}_{l}} {\sum }_{i = 1}^{M} {c}_{1 l} ( i ) [ - log \frac{Q}{{u}_{1 l} ( i )} ] \qquad ( 56 )$$

$${H}^{*} = \frac{{H}_{out}^{*} + {H}_{inn}^{*}}{2} \qquad ( 57 )$$

As described above, between the final evaluation value H★ obtained by the method described in Patent Document 3 expressed by formula (57) and the high-precision chaotic scale function H′ obtained only by the post-mapping correction described in formula (36), it is clearly different even if the equation of this embodiment does not include the measure correction before correction. In this embodiment, even when the number of divisions and the number of data are small, it is possible to obtain an evaluation value that is very close to the Lyapunov exponent.

Although multiple embodiments of the present invention have been described, these embodiments are presented as examples and are not intended to limit the scope of the invention. These novel embodiments can be implemented in various other forms, and various omissions, substitutions, and changes can be made without departing from the gist of the invention. These embodiments and their modifications are included within the scope and gist of the invention, as well as within the scope of the invention described in the claims and its equivalents.

### EXPLANATION OF SYMBOLS

100 Time Series Data Evaluation Device
101 CPU
102 Main Memory
103 Bus
104 External Storage Device
104A Time Series Data Evaluation Program
105 Time Series Data Supply Unit
106 Result Output Unit
201 Probability Calculation Unit
202 Partition Entropy Calculation Unit
202A Outer Measure Entropy Calculation Unit
202B Inner Measure Entropy Calculation Unit
203 Sum Calculation Unit
204 Actual Data Existence Rate Calculation Unit

1. A time series data evaluation device characterized by:
a mapping where τ, defined on a straight line, is set to
$$τ : I \to I ⊂ {}^{1} \qquad [ \# 1 ]$$
and for the initial value of ξ₀∈I
$${ξ}_{t} = τ ( {ξ}_{t - 1} ) = {τ}^{t} ( {ξ}_{0} ) , t = 1 , 2 , … , n$$
a total of n+1 time series data obtained by n iterations is defined as
$$\{ {ξ}_{0} , {ξ}_{1} , {ξ}_{2} , … , {ξ}_{n} \}$$
wherein the divided interval obtained by dividing the interval I including ξₜ into M equal parts is represented by Aᵢ (i=1, 2, . . . , M), and wherein the divided interval satisfies the following formula (1),
$$[ \# 2 ]$$
$$I = {U}_{i = 1}^{M} {A}_{i} , {A}_{i} ⋂ {A}_{j} = ∅ ( i \neq j ) \qquad ( 1 )$$
where c₁(i) and p(i) are determined by the following equations (2) and (4),
$$[ \#3 ]$$
$${c}_{1} ( i ) = \# \{ {ξ}_{t} ∈ {A}_{i} \vert t = 0 , 1 , 2 , … , n - 1 \} \qquad ( 2 )$$
$$p ( i ) = \frac{{c}_{1} ( i )}{n} \qquad ( 4 )$$
and being equipped with a probability calculation unit that calculates the probability p(i) that ξₜεAᵢ, and setting a subdivision section Bᵢ (i=1, 2, . . . , M×Q) by further dividing the divided section Aᵢ (i=1, 2, . . . , M) into Q equal parts, and using a division entropy calculation unit that calculates division entropy using a measure in this subdivision interval, and a summation calculation unit that performs a summation calculation of the division interval range for the multiplication of the probability p(i) and the division entropy.

2. The time-series data evaluation device according to claim 1, wherein the division entropy calculation unit includes an outer measure entropy calculation unit that calculates an outer measure entropy using an outer measure in the subdivision section.

3. The time-series data evaluation device according to claim 2, wherein the division entropy calculation unit includes an internal measure entropy calculation unit that calculates an internal measure entropy using an internal measure entropy in the subdivision interval.

4. The time-series data evaluation device according to claim 3, wherein the division entropy calculation unit uses an average value of the outer measure entropy and the inner measure entropy as the partition entropy in a summation calculation.

5. The time-series data evaluation device according to claim 4 being equipped with an actual data existence rate calculation unit that calculates the actual data existence rate wᵢ in the pre-mapping subdivision interval from wᵢ=vᵢ/W, where vᵢ is the number of pre-mapping subdivision intervals in which real data exists and the pre-mapping subdivision interval Cᵢ (i=1, 2, . . . , M×W) obtained by further dividing the division interval Aᵢ (i=1, 2, . . . , M), and the division entropy calculation unit creates a corrected outer measure entropy and a corrected inner measure entropy by correcting the outer measure entropy and the inner measure entropy using the actual data existence rate wᵢ and uses the average value of this outer-correction measure entropy and inner-correction measure entropy as the division entropy in the summation calculation.

6-10. (canceled)

11. A time series data evaluation method characterized by:
a mapping where τ, defined on a straight line, is set to
$$τ : I \to I ⊂ {}^{1} \qquad [ \# 7 ]$$
and for the initial value of ξ₀∈I
$${ξ}_{t} = τ ( {ξ}_{t - 1} ) = {τ}^{t} ( {ξ}_{0} ) , t = 1 , 2 , … , n$$
a total of n+1 time series data obtained by n iterations of is defined as
$$\{ {ξ}_{0} , {ξ}_{1} , {ξ}_{2} , … , {ξ}_{n} \}$$
and wherein the divided interval obtained by dividing the interval I including t into M equal parts is represented by Aᵢ (i=1, 2, . . . , M), and wherein the divided interval satisfies the following formula (1),
$$[ \# 8 ]$$
$$I = {U}_{i = 1}^{M} {A}_{i} , {A}_{i} ⋂ {A}_{j} = ∅ ( i \neq j ) \qquad ( 1 )$$
where c₁(i) and p(i) are determined by the following equations (2) and (4),
$$[ \#9 ]$$
$${c}_{1} ( i ) = \# \{ {ξ}_{t} ∈ {A}_{i} \vert t = 0 , 1 , 2 , … , n - 1 \} \qquad ( 2 )$$
$$p ( i ) = \frac{{c}_{1} ( i )}{n} \qquad ( 4 )$$
and being equipped with a probability calculation unit that calculates the probability p(i) that ξₜεAᵢ, and setting a subdivision section Bᵢ (i=1, 2, . . . , M×Q) by further dividing the divided section Aᵢ (i=1, 2, . . . , M) into Q equal parts, and using a division entropy calculation unit that calculates division entropy using a measure in this subdivision interval, and a summation calculation unit that performs a summation calculation of the division interval range for the multiplication of the probability p(i) and the division entropy.

12. The time-series data evaluation method according to claim 11, wherein in calculating the division entropy, an outer measure entropy is calculated using an outer measure in the subdivision section.

13. The time-series data evaluation method according to claim 12, wherein in calculating the division entropy, an internal measure entropy is calculated using an internal measure in the subdivision section.

14. The time-series data evaluation method according to claim 13, wherein in calculating the division entropy, an average value of the outer measure entropy and the inner measure entropy is used as the partition entropy in a sum calculation.

15. The time-series data evaluation method according to claim 14 using an actual data existence rate calculation unit that calculates the actual data existence rate wᵢ in the pre-mapping subdivision interval from wᵢ=vᵢ/W, where vᵢ is the number of pre-mapping subdivision intervals in which real data exists and the pre-mapping subdivision interval Cᵢ (i=1, 2, . . . , M×W) obtained by further dividing the division interval Aᵢ (i=1, 2, . . . , M), and uses the division entropy calculation unit to create a corrected outer measure entropy and a corrected inner measure entropy by correcting the outer measure entropy and the inner measure entropy using the actual data existence rate wᵢ and to use the average value of this outer-correction measure entropy and inner-correction measure entropy.
